(19) United States
(12) Patent Application Publication
(10) Pub. No.: US 2009/0254588 A1
(43) Pub. Date: Oct. 8, 2009

(54) Multi-Dimensional Data Merge

(76) Inventor: Zhong Li, Livingston, NJ (US)

Correspondence Address: GIBBONS P.C., ONE GATEWAY CENTER, NEWARK, NJ, 07102, US

(21) Appl. No.: 11/764,958

(22) Filed: Jun. 19, 2007

(51) Int. Cl. G06F 17/30

(52) U.S. Cl. 707/201; 707/E17.007

(57) ABSTRACT

The invention is directed to a system and method for merging at least two datasets each having at least two keys and each having a plurality of data elements. The system determines a quantity of shared data elements in each dataset for each key as well as a quantity of unique data elements in each dataset for each key. The system then generates a graphical output representing the quantity of shared and unique data elements in each dataset for each key. The system receives a selection input selecting one of a plurality of merge strategies. Each merge strategy is based on the quantity shared or unique data elements in each dataset for each key. The system then generates a merged dataset containing data elements from the at least two datasets based on the at least two keys and the selected merge strategy.

### FIELD OF THE INVENTION

The present invention relates to data merging systems and methods as well as graphical user interfaces that implement such data merges. In particular, the present invention relates to systems and methods for merging multi-dimensional datasets and more particularly multi-dimensional biomedical datasets.

### BACKGROUND OF THE INVENTION

Most large-scale biomedical datasets are represented in two dimensional spaces. For example, genotyping data from a case/control genetic study is usually arranged with individuals as rows and markers/phenotypes as columns. Microarray gene expression data is usually arranged with gene/markers as rows and experiments as columns.

Merging multiple datasets into a single dataset is a common data manipulation operation. However, all prior art operations on dataset merging perform the merge using a single key. For example, to merge two database tables, one containing employee's salary and the other containing employees' address, a unique identifier such as employee social security number is used as the key to merge the two tables.

To merge two datasets that have their data elements arranged in two dimensions, such as the genotyping data and microarray gene expression data, one must consider the datasets to be merged in both dimensions at the same time because all data elements in the selected datasets are described by not only one key but two keys. Accordingly, it is desirable to improved data merging techniques that simplify the process of merging such multi-dimensional datasets.

### BRIEF SUMMARY OF THE INVENTION

The invention is directed to a system and method for merging at least two datasets each having at least two keys and each having a plurality of data elements. The system determines a quantity of shared data elements in each dataset for each key as well as a quantity of unique data elements in each dataset for each key. The system then generates a graphical output representing the quantity of shared and unique data elements in each dataset for each key. The system receives a selection input selecting one of a plurality of merge strategies. Each merge strategy is based on the quantity shared or unique data elements in each dataset for each key. The system then generates a merged dataset containing data elements from the at least two datasets based on the at least two keys and the selected merge strategy.

Each dataset can have data elements arranged in two dimensions. Each dimension can be associated with a key. The system can provide up to four merge strategies in cases where each dataset has two dimensions. In cases where the datasets have additional dimensions, the system can provide additional merge strategies. Preferably, the plurality of merge strategies include only those merge strategies that will produce unique results (i.e., a merged dataset that is different from the original datasets to be merged). The system can provide a user with a graphical representation of the plurality of merge strategies. The system can also provide a graphical output representing the quantity of shared and unique data elements in each dataset for each key in the form of a map of the any overlap between the shared and unique data elements.

Each dataset can include data elements representing at least one biological characteristic. The biological characteristic can includes at least one of a genetic marker and a phenotype. The system can also provide the user with a tabular representation of the quantity of shared and unique data elements in each dataset for each key. The system can also accept user input to identify the keys for each dataset.

### BRIEF DESCRIPTION OF THE DRAWINGS

For a better understanding of the present invention, reference is made to the following description and accompanying drawings, while the scope of the invention is set forth in the appended claims:

FIG. 1 is a block diagram of an exemplary system in accordance with the invention;

FIG. 2 is an exemplary flowchart showing system operation in accordance with the invention;

FIG. 3 shows an exemplary system diagram in accordance with the invention;

FIG. 4 shows a portion of an exemplary 2-dimensional dataset in accordance with the invention;

FIG. 5 shows an exemplary merge analysis screen in accordance with the invention;

FIG. 6 shows an exemplary conflict resolution screen in accordance with the invention;

FIG. 7 shows an exemplary conflict resolution screen after all conflicts have been resolved in accordance with the invention;

FIG. 8 is an exemplary flowchart showing a meta analysis implementation in accordance with the invention; and

FIG. 9 shows the graphical representation of FIG. 5 in more detail, in accordance with the invention.

### DETAILED DESCRIPTION OF THE INVENTION

### I. System Overview

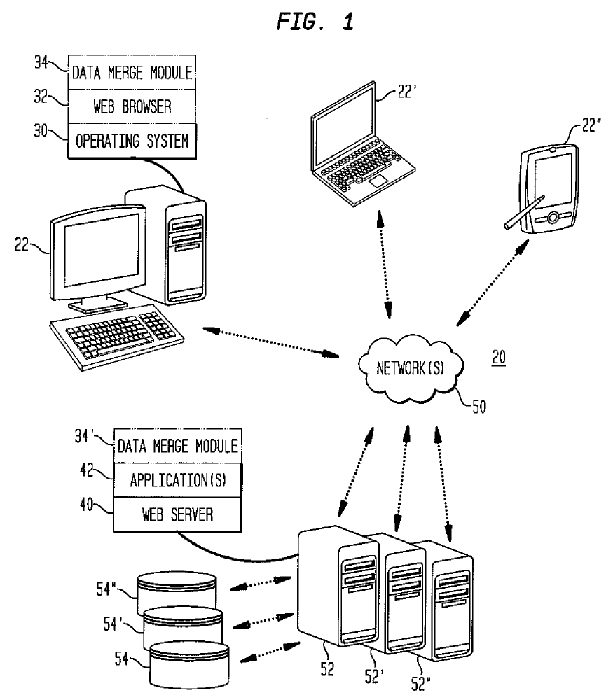

FIG. 1 shows an exemplary system diagram in accordance with the invention. The system 20 includes one or more computers or client devices 22, 22′, 22″. Computerized devices 22, 22′, 22″ represent alternate forms of computing devices that can be used in connection with the invention such as desktop computers, notebook or portable computers, PDAs and the like. It is understood that a variety of computerized devices above and beyond those shown in FIG. 1 can be used in connection with the invention. Computer 22, 22′ or 22″ can include typical hardware including a display and input devices (e.g., keyboard, mouse, touch screen . . . ) I/O ports and the like. Computer 22, 22′ or 22″ generally has an associated operating system 30 such as MICROSOFT WINDOWS or Linux and can include a typical Web Browser 32 such as MICROSOFT INTERNET EXPLORER, FIREFOX or the like. It is understood that the invention can be implemented utilizing one or more of a variety of computing environments (e.g., MICROSOFT WINDOWS, APPLE MAC OS X, LINUX, PALM OS, and the like). The hardware and software configuration of such computing devices are well known in the art.

The system can be implemented in a stand alone configuration in which the computer 22, 22′ or 22″ includes one or more software modules including a data merge module 34 that performs data merging operations in accordance with the invention. It is understood that the system can be implemented in a variety of configurations including network-based configurations such as an application service provider (ASP) configuration. In this configuration, the computer 22, 22′ or 22″ can be connected to one or more servers 52, 52′, 52″ via a network 50 (e.g., intranet, Internet or the like). FIG. 1 generally shows the data communications paths between the client devices, network and servers as dashed lines. The connection between the computers 22, 22′, 22′ and network 50 can be achieved via a variety of conventional methods (e.g., wired, wireless and the like) as is well known in the art. It is also understood that a variety of data networks using various network protocols are suitable for use in accordance with the invention (e.g., TCP/IP, HTTP . . . ). It is further understood that communications via the Internet often traverse a series of intermediate network nodes prior to reaching the desired destination. The arrows shown in FIG. 1 do not suggest a direct physical connection between the users, networks and servers and encompass typical network and/or Internet communications (a connectionless, best-efforts packet-based system).

In this example, the server(s) are generally associated a plurality of software modules including one or more applications 42, a web server 40 and a data merge module 34′ as discussed in more detail below. In this configuration the computer 22, 22′ or 22″ can function simply as a thin client. It is understood that several variations are possible without departing from the scope of the invention. For example, the data merge module 34, 34′ can be executed by processors contained in the computer 22, 22′ or 22″, servers 52, 52′, 52″ or combination thereof. The software portion of the invention can be implemented in a variety of configurations such as a stand-alone program or SDK for use with general computing hardware. The software portion of the invention can also be implemented as executable code on a computer readable medium.

### II. System Operation

In general, the invention is directed to systems and methods for merging at least two datasets having multi-dimensional data. The invention is particularly useful where each dataset includes biological/medical/clinical characteristics (i.e., biomedical datasets). In this context, each dataset involved in the merge contains at least two keys. For example, for genotyping data, one key (e.g., individual ID) can be an identifier that uniquely identifies an individual from whom the genotyping data come from, and the other key (e.g., marker ID) can be an identifier that uniquely identifies a marker on which a pair of allele information is provided for each individual. Yet another key can be an identifier (phenotype ID) that uniquely identifies a phenotype for each individual.

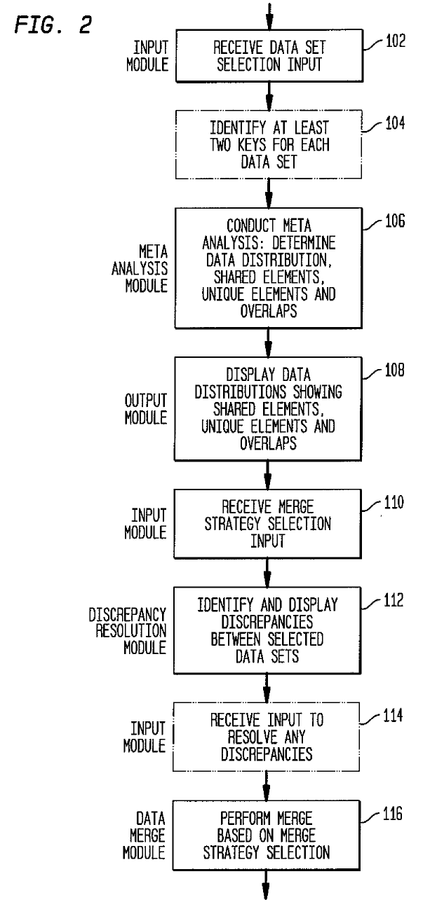

FIG. 2 shows an exemplary flowchart showing system operation In accordance with the invention. It is understood that the flowcharts contained herein are illustrative only and that other program entry and exit points, time out functions, error checking routines and the like (not shown) would normally be implemented in typical system software. It is also understood that some of the individual blocks may be implemented as part of an iterative process. It is also understood that the system software can be implemented to run continuously. Accordingly any beginning and ending blocks are intended to indicate logical beginning and ending points of a portion of code that can be integrated into a main program and called as needed to support continuous system operation. Implementation of these aspects of the invention is readily apparent and well within the grasp of those skilled in the art based on the disclosure herein. When implementing software code associated with the flowcharts contained herein, the code can be broken up into several modules as generally shown in FIG. 2, including: an input module, meta analysis module, output module, discrepancy resolution module and data merge module. It is understood that the various system function can be broken down in a variety of configurations without departing from the scope of the invention.

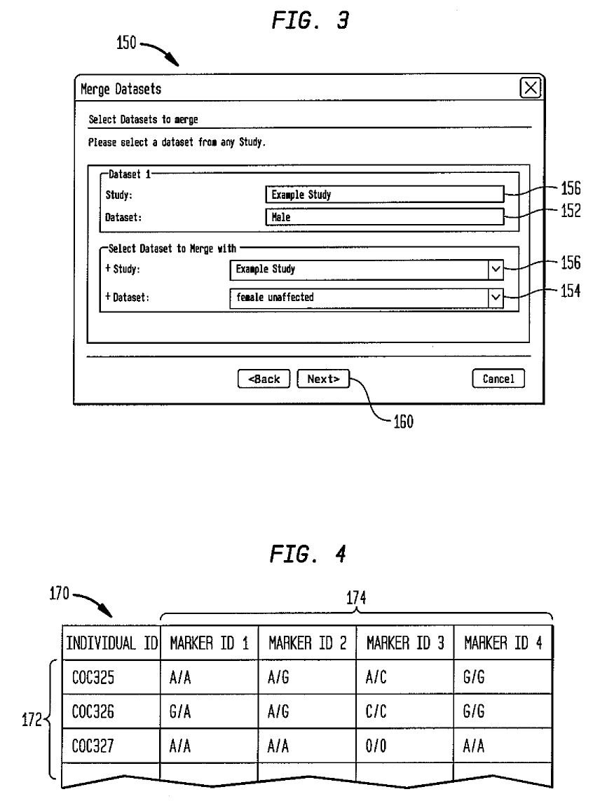

In operation, the user selects two or more datasets for processing. An exemplary input select screen 150 is shown in FIG. 3. In general, the user identifies a first and second dataset 152, 154. The various datasets can be stored locally or remotely and can be organized via a variety of methods including folder structures and the like. In this example, the datasets are grouped by the particular study under which they were generated. The input screen also provides the user with study select option 156, 158. Once the desired datasets are selected, the user selects the next button 160. The system receives the selection as shown by block 102 (FIG. 2).

The system then identifies at least two keys for each data set as shown by block 104. In a typical case, key selection is based on the input file format. As discussed above, for genotyping data, one key (e.g., individual ID) can be an identifier that uniquely identifies an individual from whom the genotyping data come from, and the other key (e.g., marker ID) can be an identifier that uniquely identifies a marker on which a pair of allele information is provided for each individual. Yet another key can be an identifier (phenotype ID) that uniquely identifies a phenotype for each individual. It is understood that the system can also provide the user with an input screen to select the desired keys associated with a dataset.

FIG. 4 shows a portion of an exemplary dataset 170 in accordance with the invention. In this example, the data is arranged in row-column format. The first key is Individual ID 172 and the second key Marker ID 174. It is readily apparent that each Individual ID can be associated with a plurality of Marker IDs. For purposes of this example it is assumed that each of the datasets will have the same two keys namely Individual ID and Marker ID.

The system then determines the number of partially or completely shared data elements in each dataset for each key as shown by block 106 (FIG. 2). For example, two datasets, each having two keys, are selected for the merge. Shared data elements in both datasets are identified in each dataset for each key. In another example, three datasets, each having two keys, are selected for a merge operation. In this case, completely shared data elements in all three datasets are identified in each dataset for each key. In addition, shared data elements in any two out of three datasets are identified in each dataset for each key. The system also determines the number of unique data elements in each dataset for each key. The above analysis of shared and unique data elements in each datasets involved in a merge is called meta analysis and is discussed in more detail below.

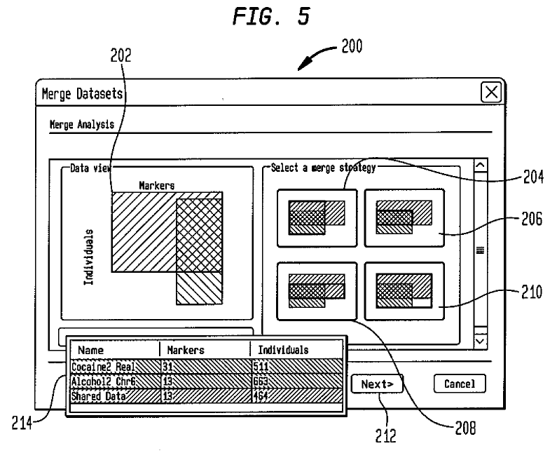

The system generates an output to represent the result of the meta analysis as shown by block 108. A graphical representation, a tabular representation, or both graphical and tabular representations can be used to represent the result of the meta analysis. FIG. 5 shows an exemplary merge analysis screen 200 in accordance with the invention. In this example, the merge analysis screen includes a graphical meta analysis representation 202 and a tabular meta analysis representation 214. The system also determines possible merge strategies based on the result of the meta analysis and displays a graphical representation for each possible merge strategy 204, 206, 208, 210. To merge two datasets each with two keys, at most four merge strategies are possible. Depending on the nature of the datasets, zero, one, two, three, or four merge strategies are possible when merging two datasets each with two keys.

The user reviews the merge strategies and selects one of the strategies by clicking on one of the graphical representations 204, 206, 208, 210. After a user selects one of the possible merge strategies, the next button 212 can be selected. The system receives the merge strategy selection as shown by block 110 (FIG. 2). The system will then begin the merge process to generate a merged dataset containing data elements from the selected datasets satisfying the selected merge strategy. In the process, duplicated data elements will be reduced into unique data elements as shown by block 112.

In general, if one data element exists in both datasets and is targeted to be included in the merged dataset, the values for its attributes (e.g., phenotypes, markers . . . ) in the first dataset are compared with the values for the corresponding attributes in the second dataset. If all values for all attributes for the data element in both datasets are identical, the data element is considered to exist in duplicate in the merged dataset and therefore one of the duplicates will be removed. As a result, each data element in the merged dataset is unique.

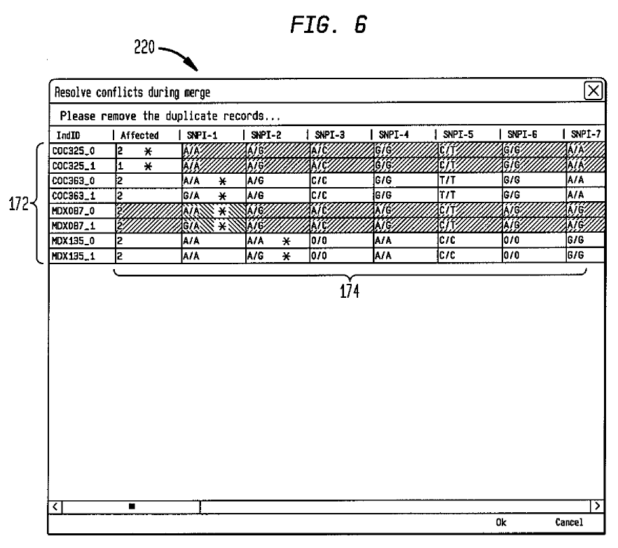

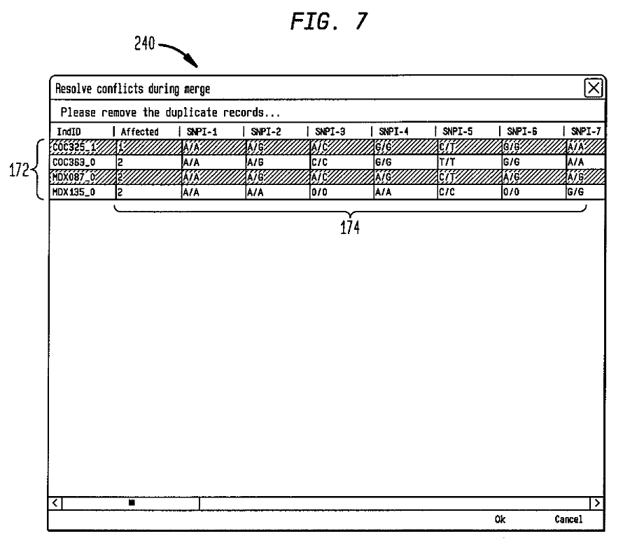

If data discrepancy is identified during the merge, affected data are displayed to allow a user to resolve the discrepancy as shown by 114. FIG. 6 shows an exemplary conflict resolution screen 220 in accordance with the invention. In general, the conflict resolution screen identifies any records having conflicting data. For example, two records with the same Individual ID 172 having inconsistent data associated with one or more Marker IDs 174 or one or more phenotype IDs. In the example shown, four Individual IDs are associated with inconsistent Marker ID/Phenotype ID data. For purposes of clarity, the Individual IDs are appended with “_{—}0” or “_{—}1” to denote the dataset from which the data is derived. The various Marker IDs/Phenotype ID are displayed and the inconsistent data is highlighted (e.g., via an asterisk, color, shading or the like). The user can simply click on the specific Individual IDs that they wish to remove from the merge process. FIG. 7 shows an exemplary conflict resolution screen 240 after all conflicts have been resolved in accordance with the invention.

Upon the resolution of all data discrepancies or if no data discrepancy is identified, the merge process will continue to generate a merged dataset containing data elements from involved datasets satisfying the selected merge strategy as shown by block 116. One technical effect of the present invention is that it is the first to provide a mechanism to allow users to merge two or more datasets each with two or more keys in one operation with the need to write any custom programming code. Another technical effect of the present invention is that it provides an intuitive user interface, especially for the novice users. Another technical effect of the present invention is that it provides a visual presentation of the relationship between/among datasets to be merged as well as counts of shared or unique data elements in each dataset, thus providing immediate help to user to understand the data and determine subsequent merge strategy. Another technical effect of the present invention is that it searches exhaustively for all possible merge strategies and presents only the merge strategies that are applicable to the datasets to be merged. A graphical representation of the applicable merge strategies makes it extremely easy for a user to understand the application strategies and select a strategy to perform the merge. Another technical effect of the present invention is that during the merge process, duplicated data elements are automatically reduced into unique data elements. Furthermore, duplicated data elements with discrepancies are identified and clearly flagged in a user interface. The user interface provides an intuitive mechanism for the user to resolve discrepancy and complete the merge. Another technical effect of the present invention is that the datasets to be merged can be drawn from all types of data storage, such as RAM, local disk, network storage, database, files, etc. The merged dataset can be stored in all types of data storage as well.

### III. Meta Analysis

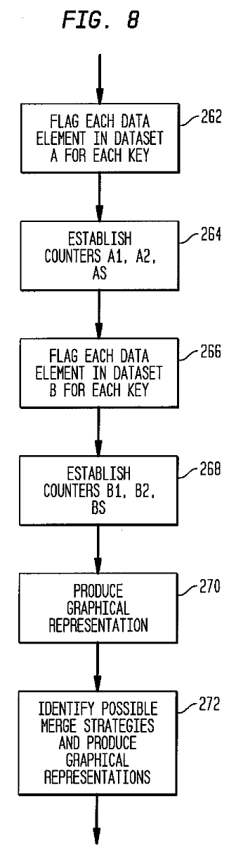

As discussed above, the system conducts meta analysis to identify shared data elements in any of the selected datasets for each key. The system also determines the number of unique data elements in each dataset for each key. FIG. 8 is an exemplary flowchart showing a meta analysis implementation in accordance with the invention. In one implementation of the present invention, each of the datasets selected for the multi-dimensional merge process are represented as data objects in computer memory. Assume for this example the merge process involves two datasets (dataset 1 and dataset 2, for example), each contains two keys (key A and key B, for example), the process can be described as set out in FIG. 8 and as described below.

Each data element in key A for dataset 1 and dataset 2 is interrogated and is flagged as either “unique to dataset 1 for key A”, “unique to dataset 2 for key A”, or “shared by dataset 1 and dataset 2 for key A” as shown by block 262. Three counters (e.g., counters A1, A2, AS) are established, capturing the counts for the number of data elements in key A that have flags “unique to dataset 1 for key A”, “unique to dataset 2 for key A”, or “shared by dataset 1 and dataset 2 for key A”, respectively as shown by block 264.

Each data element in key B for dataset 1 and dataset 2 is interrogated and is flagged as either “unique to dataset 1 for key B”, “unique to dataset 2 for key B”, or “shared by dataset 1 and dataset 2 for key B” as shown by block 266. Three counters (e.g., counters B1, B2, BS) are established, capturing the counts for the number of data elements in key B that have flags “unique to dataset 1 for key B”, “unique to dataset 2 for key B”, or “shared by dataset 1 and dataset 2 for key B”, respectively as shown by block 268.

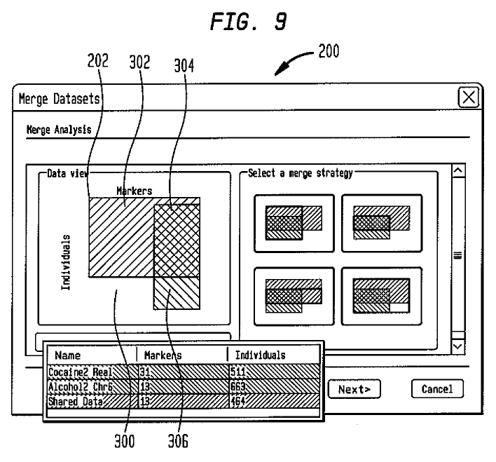

A graphical representation displaying the nature of the selected two datasets and their relationship in terms of the number of shared or unique data elements for each of the two keys is produced using the three counters for key A and three counters for key B as shown by block 270. FIG. 9 shows the exemplary graphical representation 202 in more detail. In general the graph 202 represents the quantity of shared and unique data elements in each dataset for each key. The Y Axis represents whether there is any overlap for Key A (e.g., Individual ID). The X Axis represents whether there is any overlap for Key B (e.g., Marker IDs). Depending on the shared nature between two datasets, the graph can have up to 9 distinct areas (for example under the condition O<AS<(A1 and A2) and O<BS<(B1 and B2)). For the example shown in FIG. 9, the graph is broken up into six distinct areas namely i) unique Marker ID for dataset 1 and unique Individual ID for dataset 2 300, ii) shared Individual IDs for both datasets but unique Marker ID for dataset 1 302, iii) shared Individual IDs and shared Marker IDs for both datasets 304, iv) shared Marker IDs for both datasets but unique Individual IDs for dataset 2 306, v) unique Individual IDs and unique Marker IDs for dataset 1 308, and vi) unique Individual IDs and shared Marker IDs for dataset 1 310. In this particular example there is a large amount of data in category ii (shared Individual IDs for both datasets but unique Marker IDs for dataset 1). A small portion of data is in the remaining three categories.

To render the graphical representation 202, three rectangles are drawn using the counters for key A and key B: for example, Rect1 for dataset 1, Rect 2 for dataset 2, and RectShared for shared data between datasets 1 and 2. The length (Axis X) and width (Axis Y) of each rectangle are determined by the counters for key B and key A, respectively. For example, the width of Rect1 is calculated as A1/(A1+A2−AS)*maxY, in which maxY is the fixed size for the Y Axis for the graph area (200 pixels, for example) and maxX is the fixed size for the X Axis for the graph area (200 pixels, for example). In the current implementation, the rectangle for dataset 1 is always positioned at the top left corner with the following four corner coordinates:

(0, (A1+A2−AS)/(A1+A2−AS)*maxY);

(B1/(B1+B2−BS)*maxX, (A1+A2−AS)/(A1+A2−AS)*maxY);

(0, A2−AS/(A1+A2−AS)*maxY); and

(B1/(B1+B2−BS)*maxX, (A2−AS)/(A1+A2−AS)*maxY).

The rectangle of the dataset 2 is positioned depending on the values of the AS and BS counters with the following four corner coordinates:

((B1−BS)/(B1+B2−BS)*maxX, A2/(A1+A2−AS)*maxY);

((B1+B2−BS)/(B1+B2−BS)*maxX, A2/(A1+A2−AS)*maxY);

((B1−BS)/(B1+B2−BS)*maxX, 0); and

((B1+B2−BS)/(B1+B2−BS)*maxX, 0)

The rectangle of the shared data is described with the following four corner coordinates:

((B1−BS)/(B1+B2−BS)*maxX, A2/(A1+A2−AS)*maxY);

(B1/(B1+B2−BS)*maxX, A2/(A1+A2−AS)*maxY);

(B1/(B1+B2−BS)*maxX, (A2−AS)/(A1+A2−AS)*maxY); and

((B1−BS)/(B1+B2−BS)*maxX, (A2−AS)/(A1+A2−AS)*maxY)

Depending on the values of the three counters for key A and three counters for key B, either no merge strategy is shown, or one or more (up to four for merging two datasets with two keys) merge strategies are shown with corresponding graphical representations as shown by block 272. Exemplary graphical representations of merge strategies are shown by reference numbers 204, 206, 208, 210 in FIG. 5.

Identification of the applicable merge strategies is described in more detail below. Three are only 5 possible relationships among the three counters for key A:
a. AS=0 (no shared data element)
b. 0<AS<(A1 and A2)
c. AS=A1=A2
d. AS=A1<A2
e. AS=A2<A1

Similarly, three are only 5 possible relationships among the three counters for key B:
a. BS=0 (no shared data element)
b. 0<BS<(B1 and B2)
c. BS−B1=B2
d. BS=B1<B2
e. BS=B2<B1

Based on the above, there are only 25 possible combined relationships among the three counters for keys A and B. For each of the 25 possible combined relationships among the three counters for keys A and B, zero, one, two, three, or four available merge strategies that will produce unique results (i.e., a merged dataset that is different from the original datasets to be merged). For each merge strategy, a graphical representation is made and displayed. Several examples are set out below:

Assume for example the nature of the selected two datasets yields the following combined relationships among the three counters for key A and three counters for key B: 1<AS<(A1 and A2) and BS=B1=B2, which indicates that all data elements on key B are shared between these two datasets and only a portion of each of the two datasets are shared on key A, there are only two merge strategies that will produce unique results (all four strategies are possible but two of them are not meaningful since they will produce a merge dataset that is the same as one of the input datasets). In this case the particular datasets have two available merge strategies: (1) produce a dataset that contains only the shared data elements on both keys; and (2) produce a dataset that contains both the shared and unique data elements on either key.

In another example, as shown in FIG. 9, assume the nature of the selected two datasets yields the following combined relationships among the three counters for keys A and B: 1<AS<(A1 and A2) and BS=B2<B1, which indicates that all data elements in dataset 1 on key B are shared between these two datasets; some data elements in dataset 1 on key B are unique to dataset 1; and only a portion of each of the two datasets are shared on key A. In this case there are four available merge strategies as shown in Table 1 below: (1) produce a dataset that contains only the shared data elements on both keys; (2) produce a dataset that contains both the shared and unique data elements on either key; (3) produce a dataset that contains the shared data elements on key A only; and (4) produce a dataset that contains the shared data elements on key B only.

In yet another example, assume the nature of the selected two datasets yields the following combined relationships among the three counters for keys A and B: AS=A1=A2 and BS=B1 B2, which indicates that all data elements on key A are shared between these two datasets; all data elements in dataset 1 on key B are shared between these two datasets; some data elements in dataset 2 on key B are unique to dataset 2. In this case there are no available meaningful strategies (note all four strategies are possible but none of them are meaningful since they will produce a merge dataset that is the same as one of the input datasets).

For this example, the number of available merge strategies based on the various counter relationships is shown in Table 1 below:

TABLE 1

| | AS = 0 | 0 < AS < (A1 and A2) | AS = A1 = A2 | AS = A1 < A2 | AS = A2 < A1 |
|---|---|---|---|---|---|
| BS = 0 | 1 | 2 | 1 | 2 | 2 |
| 0 < BS < (B1 and B2) | 2 | 4 | 2 | 4 | 4 |
| BS = B1 = B2 | 1 | 2 | 0 | 0 | 0 |
| BS = B1 < B2 | 2 | 4 | 0 | 2 | 2 |
| BS = B2 < B1 | 2 | 4 | 0 | 2 | 2 |

Table 1 shows that zero, one, two, or four available merge strategies can produce unique results (where two datasets each having two keys are merged). Based on the foregoing, it is readily apparent that the process can be expanded to scenarios in three or more datasets are merged. The same process could be expanded to process datasets having more than two dimensions without departing from the scope of the invention. For example, for datasets with three keys (e.g., Individual ID, Marker ID, Phenotype ID), if the merge is done with two keys (e.g., Individual ID and Marker ID), data on the third key (Phenotype ID in this case) will still need to be handled even if the merging criteria only considers two keys. One possible way to approach the problem is to perform outer-joint (both shared and unique data elements) for Phenotype ID keys and remove duplicates and resolve discrepancies the same way as Individual IDs and Marker IDs. Alternatively, the system can provide the user with options to dictate what they want to do with the additional keys which in turn might affect the number of available merge strategies. While the foregoing description and drawings represent the preferred embodiments of the present invention, it will be understood that various changes and modifications may be made without departing from the scope of the present invention.

What is claimed is:

1. A method of merging at least two datasets each having at least two keys and each having a plurality of data elements, the method comprising:
determining a quantity of shared data elements in each dataset for each key;
determining a quantity of unique data elements in each dataset for each key;
generating a graphical output representing the quantity of shared and unique data elements in each dataset for each key;
receiving a selection input selecting one of a plurality of merge strategies, each merge strategy being based on the quantity shared or unique data elements in each dataset for each key; and
generating a merged dataset containing data elements from the at least two datasets based on the at least two keys and the selected merge strategy.

2. The method of claim 1 wherein each dataset has data elements arranged in two dimensions.

3. The method of claim 2 wherein each dimension is associated with a key.

4. The method of claim 1 wherein the plurality of merge strategies comprises up to four merge strategies.

5. The method of claim 1 wherein the plurality of merge strategies comprises only those merge strategies that will produce unique results.

6. The method of claim 1 comprising generating a graphical representation of the plurality of merge strategies.

7. The method of claim 1 wherein the graphical output representing the quantity of shared and unique data elements in each dataset for each key is a map of the any overlap between the shared and unique data elements.

8. The method of claim 1 wherein each dataset each has data elements representing at least one biological characteristic.

9. The method of claim 8 wherein the at least one biological characteristic includes at least one of a genetic marker and a phenotype.

10. The method of claim 1 comprising generating a tabular representation of the quantity of shared and unique data elements in each dataset for each key.

11. The method of claim 1 comprising identifying at least two keys for each dataset.

12. A system of merging at least two datasets each having at least two keys and each having a plurality of data elements, the system comprising.
a meta analysis module that determines a quantity of shared data elements in each dataset for each key and a quantity of unique data elements in each dataset for each key and generates a graphical output representing the quantity of shared and unique data elements in each dataset for each key;
an input module that receives a selection input to select one of a plurality of merge strategies, each merge strategy being based on the quantity shared or unique data elements in each dataset for each key; and
a data merge module that generates a merged dataset containing data elements from the at least two datasets based on the at least two keys and the selected merge strategy.

13. The system of claim 12 wherein each dataset has data elements arranged in two dimensions.

14. The system of claim 13 wherein each dimension is associated with a key.

15. The system of claim 12 wherein the plurality of merge strategies comprises up to four merge strategies.

16. The system of claim 12 wherein the plurality of merge strategies comprises only those merge strategies that will produce unique results.

17. The system of claim 12 wherein the meta analysis module generates a graphical representation of the plurality of merge strategies.

18. The system of claim 12 wherein the graphical output representing the quantity of shared and unique data elements in each dataset for each key is a map of the overlap between the shared and unique data elements.

19. The system of claim 12 wherein each dataset each has data elements representing at least one biological characteristic.

20. The system of claim 19 wherein the at least one biological characteristic includes at least one of a genetic marker and a phenotype.

21. The system of claim 12 wherein the meta analysis module generates a tabular representation of the quantity of shared and unique data elements in each dataset for each key.

22. The system of claim 12 wherein the input module receives a selection input identifying at least two keys for each dataset.

23. The system of claim 12 wherein the meta analysis module, input module and data merge module are implemented on a computer readable medium.

24. A system of merging at least two datasets each having at least two keys and each having a plurality of data elements, the system comprising:
a means for determining a quantity of shared data elements in each dataset for each key and a quantity of unique data elements in each dataset for each key and generates a graphical output representing the quantity of shared and unique data elements in each dataset for each key;
a means for receiving selection input to select one of a plurality of merge strategies, each merge strategy being based on the quantity shared or unique data elements in each dataset for each key; and
a means for generating a merged dataset containing data elements from the at least two datasets based on the at least two keys and the selected merge strategy.
